(19) United States
(12) Patent Application Publication
(10) Pub. No.: US 2008/0135268 A1
(43) Pub. Date: Jun. 12, 2008

(54) ELECTRICALLY POWERED TOOL WITH UNHEAT GRIP PORTION

(76) Inventors: Naoki TADOKORO, Hitachinaka-shi (JP); Takuya Teranishi, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/941,430

(22) Filed: Nov. 16, 2007

(30) Foreign Application Priority Data
Nov. 17, 2006 (JP) P2006-312139

(51) Int. Cl. H02K 7/14; H02K 11/00

(52) U.S. Cl. 173/2; 310/50; 310/68 A

(57) ABSTRACT

In order to prevent the grip portion of a power tool from heating up, a brake resistor in which a regenerative current generated by a motor flows is disposed in a tail portion of the handle. The brake resistor is composed of two resistor elements connected in parallel with each other. The two resistor elements are mounted on different surfaces of a circuit board to effectively utilize an interior space of the handle.

### BACKGROUND OF THE INVENTION

1. Field of the Invention

The present invention relates generally to an electrically powered tool (hereinafter referred simply to as “power tool”), and more particularly to an arrangement of heat generating resistors used in a motor control circuit.

2. Description of the Related Art

A conventional power tool and a motor control circuit used therein are described, for example, in Japanese Patent Application Publication No. 2002-281777. FIG. 1 is a partial cross-sectional view of a conventional impact driver 10, and FIG. 2 is a circuit diagram of the motor control circuit 20 used in the impact driver 10 shown in FIG. 1.

The motor control circuit 20 shown in FIG. 2 includes a speed controllable switch 2, a diode bridge 3, a forward/reverse switching circuit 5, a DC motor 6, and a brake circuit 4. The speed controllable switch 1 is connected to a commercial AC power supply 1 and operates to control a voltage to be applied to the DC motor 6 depending upon how deep a trigger switch 7 (see FIG. 1) of the impact driver 10 is pulled. The diode bridge 3 performs either a half-wave or full-wave rectification of the AC voltage and supplies a DC voltage to the DC motor 6 through the forward/reverse switching circuit 5.

The brake circuit 4 is configured from a normally closed contact 4a (hereinafter referred to as “NC contact 4a”) and a resistive coil 4b. The NC contact 4a and the resistive coil 4b are connected in series across positive terminal A and negative terminal B of the DC side so that a closed loop is formed by the motor 6, the resistive coil 4b, and the NC contact 4a when the NC contact 4a is closed.

When the operator removes his or her finger from the trigger switch 7 to stop driving the impact driver 10, the speed controllable switch 2 turns off and the NC contact 4a of the brake circuit 4 turns on, allowing a regenerative current or a brake current Ix to flow in the closed loop formed by the motor 6, the resistive coil 4b, and the NC contact 4a.

As shown in FIG. 1, a board 8 on which the resistive coil 4b is mounted is disposed inside of the grip portion 11a and behind the trigger switch 7. When consecutively driving a number of small-size screws into a workpiece with the impact driver 10, the trigger switch 7 is repeatedly turned on and off. Each time the trigger switch 7 is turned off, the brake current flows in the resistive coil 4b and generates heat. Due to the heat generated by the resistive coil 4b, the grip portion 11a of the handle 11 can be heated up to a degree that the operator cannot keep on grasping the impact driver 10.

### SUMMARY OF THE INVENTION

In view of the foregoing, it is an object of the invention to obviate the problems involved in the conventional power tools.

To achieve the above and other objects, there is provided a power tool that includes a motor; a main housing in which the motor is accommodated; a handle; a switch circuit; and a brake circuit. The handle has a tail portion and a grip portion. An operator grips the grip portion when driving the power tool. The grip portion has one end integral with the main housing and another end integral with the tail portion. The switch circuit is connected between a power supply and the motor and controls the motor. The brake circuit includes a resistor and is connected to the motor for allowing a regenerative current generated by the motor to flow when a driving current flowing in the motor is interrupted, wherein the resistor is disposed in the tail portion to which the operator's hand does not normally extend when the operator grasps the grip portion. Accordingly, heat generated from the resistor of the brake circuit does not cause the grip portion to heat up.

It is desirable that the resistor of the brake circuit is made up of a first resistor element and a second resistor element connected in parallel with each other. With the parallel-connection of two resistors, a resistance value can be decreased, thereby decreasing the amount of heat generated from the resistors. In this case, in terms of effectively utilizing an internal space of the handle, it is further desirable to mount the first and second resistor elements on front and rear surfaces of a circuit board, respectively.

It is desirable that the brake circuit further include a contact that is held open when the driving current flows in the motor and is closed when the driving current flowing in the motor is interrupted.

It is also desirable that the tail portion be protruded outwardly from the grip portion in an axial direction of the main housing.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view showing a part of a conventional impact driver;

FIG. 2 is a circuit diagram showing a motor control circuit used in the impact driver shown in FIG. 1;

FIG. 3 is a cross-sectional view showing a part of an impact driver according to an embodiment of the invention;

FIG. 4 is a circuit diagram showing a motor control circuit used in the impact driver shown in FIG. 3;

FIG. 5A is a rear view showing a circuit board for mounting a brake resistor according to the embodiment of the invention;

FIG. 5B is a front view showing the circuit board for mounting another brake resistor according to the embodiment of the invention; and

FIG. 6 is a side view showing a grip portion of the impact driver.

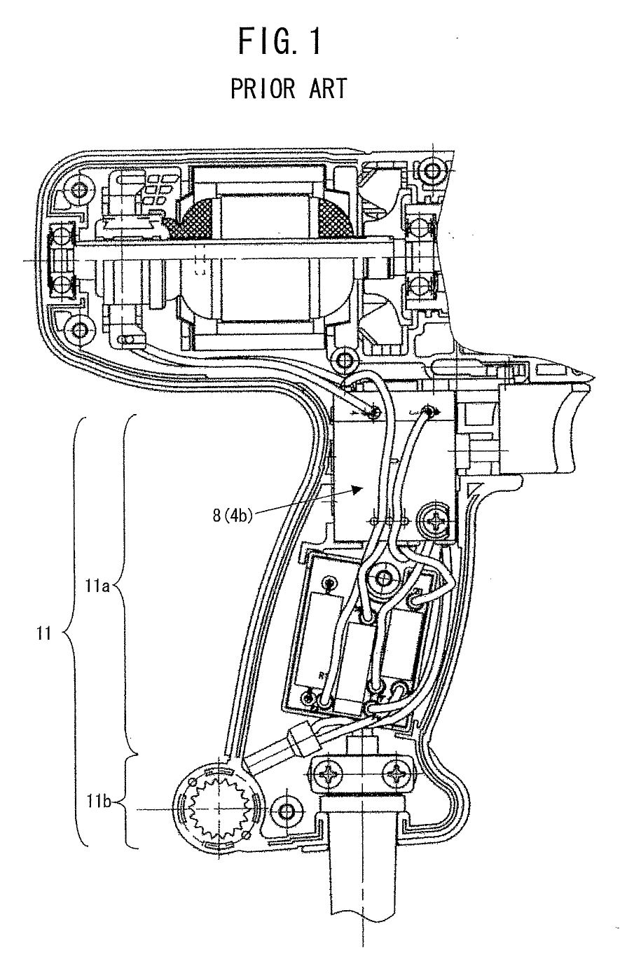

### DETAILED DESCRIPTION OF THE PREFERRED EMBODIMENTS

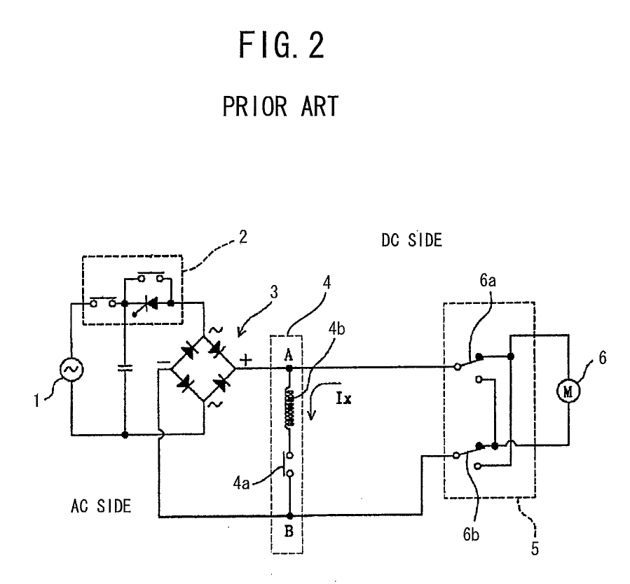

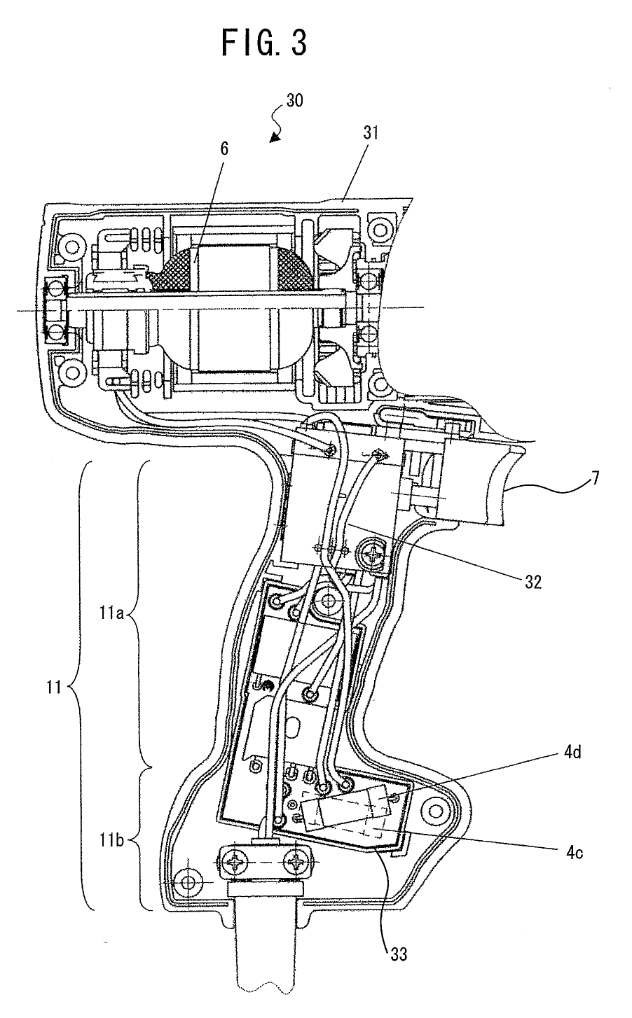

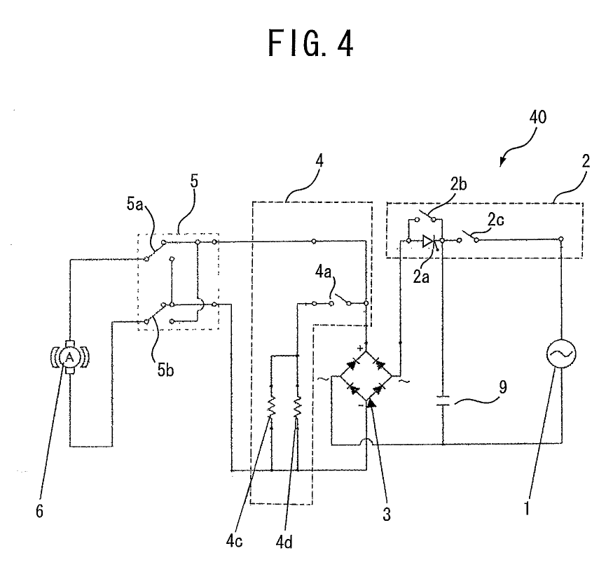

An embodiment of the invention will be described with reference to FIGS. 3 to 6, in which the invention is applied to an impact driver. In the circuit diagrams in FIGS. 2 and 4, the same or corresponding components are designated by the same reference numerals.

As shown in FIG. 3, the impact driver 30 includes a main housing 31 and a handle 11 extending substantially orthogonal to an axial direction of the main housing 31 but slightly slanted toward the rearmost end of the main housing 31. The handle 11 has a grip portion 11a joined at one side to the main housing 31 and is integral with the main housing 31. Also, the handle 11 has a tail portion 11b integral with the grip portion 11a.

A DC motor 6 is accommodated in the rear portion of the main housing 31. Although not shown in FIG. 3, an impact mechanism is also accommodated in the main housing 31 for generating impact and drive force when driving power is supplied from the DC motor 6. With the impact and drive force, a fastener, such as a screw, is tightened into a workpiece. A switch circuit board 32 is disposed in the upper part of the grip portion 53a and behind a trigger switch 7.

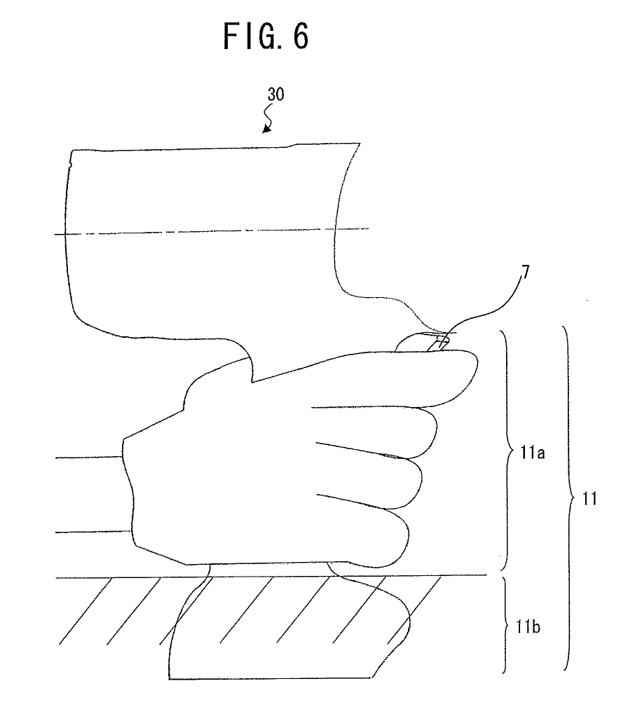

As shown in FIG. 6, the grip portion 11a is a portion where an operator grasps when driving the impact driver 30. The grip portion 11a has a size fitted to the general size of a human hand. When the operator grasps the grip portion 11a, the operator's hand does not generally extend to the tail portion 11b. The tail portion 11b is protruded outwardly from the grip portion 11a in an axial direction of the main housing 31 so that the impact driver 30 does not easily fall down when the impact driver 30 is held by the operator upside down.

As shown in FIG. 4, a motor control circuit 40 includes a switch circuit configured from a speed controllable switch 2 and a diode bridge 3. The speed controllable switch 2 is configured from two normally open contacts (hereinafter referred to as “NO contacts”) 2b and 2c, and a thyristor 2a connected in parallel with the NO contact 2b. The NO contacts 2b and 2c operate in ganged with a trigger switch 7 (see FIGS. 3 and 6). The diode bridge 3 performs a half-wave or a full-wave rectification of an AC output from an AC power supply 1 and applies a DC power to the DC motor 6.

A forward/reverse switching circuit 5 is interposed between the diode bridge 3 and the DC motor 6. The forward/reverse switching circuit 5 is configured from forward/reverse switching contacts 5a and 5b for switching a rotational direction of the DC motor 6. Further, a capacitor 9 is connected across the AC power supply 1 for suppressing noises generated when operating the impact driver 30.

The motor control circuit in FIG. 4 further includes a brake circuit 4. The brake circuit 4 is configured from an NC contact 4a and two resistors 4c and 4d connected in parallel with each other. The NC contact 4a and the parallel-connected resistors 4c and 4d are connected in series across the positive and negative terminals of the diode bridge 3. When the NC contact 4a is closed, the brake circuit 4 forms a closed loop with the motor 10 and the forward/reverse switching circuit 5. The NC contact 4a is closed when the two NO contacts 3 and 4 of the speed controllable switch 2 are simultaneously opened. This occurs when the operator removes his or her finger from the trigger switch 7.

In operation, when the operator pulls the trigger switch 7 to a level less than the maximum, the NO contact 2b is closed and the NO contact 2c is held open. Thus, a driving current flows in the motor 6 through a path including the diode bridge 3 and the contact 5a of the forward/reverse switching circuit 5, and the current flowing out from the DC motor 6 flows in a path including the contact 5b of the forward/reverse switching circuit 5, the diode bridge 3, and the thyristor 2a and the NO contact 2c of the speed controllable switch 2. The driving current flowing in the DC motor 6 corresponds to the level or depth of the trigger switch 7 pulled.

When the operator pulls the trigger switch 7 up to the maximum or to the full depth, both the NO contacts 2b and 2c of the speed controllable switch 2 are closed. In this case, the diode bridge 3 performs a full-wave rectification of the AC voltage, so that the driving current is approximately doubled as compared with the case where the trigger switch 7 is pulled to a half way. More specifically, in addition to the driving current flowing in the path described above, the driving current further flows in the DC motor 6 through a path including the NO contact 2b, the diode bridge 3, the contact 5a of the forward/reverse switching circuit 5, and the current flowing out from the DC motor 6 flows in a path including the contact 5b of the forward/reverse switching circuit 5, the diode bridge 3, and the NO contact 2b.

When the operator removes his or her finger from the trigger switch 7, the NO contacts 2b and 2c are simultaneously opened, and at the same time, the NC contact 4a of the brake circuit 4 is closed. As a result, a regenerative current or brake current generated by the DC motor 6 flows in the closed loop formed by the brake circuit 4, forward/reverse switching circuit 5, and the DC motor 6. Due to the parallel-connection of two resistors 4c and 4d, the brake current flowing in each of the resistors 4c and 4d is reduced and heat generated therefrom is also reduced as compared with the case where a single resistor is employed.

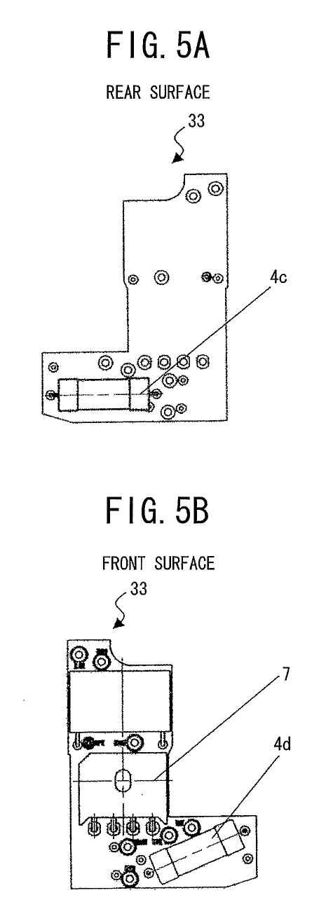

As shown in FIGS. 5A and 5B, one of the two resistors 4c and 4d is mounted on a rear surface of a circuit board 33 and the counterpart resistor 4d is mounted on a front surface of the same circuit board 33. The circuit board 33 on which the two resistors 4c and 4d are mounted is disposed in the tail portion 11b of the handle 11. According, the heat generated from the resistors 4c and 4d does not substantially rise the temperature of the grip portion 11a.

While the invention has been described in detail with reference to a specific embodiment thereof, it would be apparent to those skilled in the art that many modifications and variations may be made therein. For example, the present invention can be applied not only to an impact driver but also to all kinds of power tools using a DC motor.

What is claimed is:

1. A power tool comprising:
a motor;
a main housing in which the motor is accommodated;
a handle having a tail portion and a grip portion where an operator grips when driving the power tool, the grip portion having one end integral with the main housing and another end integral with the tail portion;
a switch circuit that is connected between a power supply and the motor and controls the motor; and
a brake circuit that includes a resistor and is connected to the motor for allowing a regenerative current generated by the motor to flow when a driving current flowing in the motor is interrupted, wherein the resistor is disposed in the tail portion.

2. The power tool according to claim 1, wherein the resistor comprises a first resistor element and a second resistor element connected in parallel with each other.

3. The power tool according to claim 2, further comprising a circuit board having a first major surface and a second major surface opposite the first major surface, wherein the first and second resistor elements are mounted on the first and second major surfaces, respectively.

4. The power tool according to claim 3, wherein the brake circuit further includes a contact that is held open when the driving current flows in the motor and is closed when the driving current flowing in the motor is interrupted.

5. The power tool according to claim 3, wherein the tail portion is protruded outwardly from the grip portion in an axial direction of the main housing.
